(19) United States
(12) Patent Application Publication
(10) Pub. No.: US 2026/0023352 A1
(43) Pub. Date: Jan. 22, 2026

(54) SYSTEM AND METHOD FOR PLANT LOGBOOK ANALYSIS POWERED BY NEURAL NETWORK

(71) Applicant: Honeywell International Inc., Charlotte, NC (US)

(72) Inventors: Viraj Srivastava, Bangalore (IN); Minal Dani, Bangalore (IN); Amrutha Kalibhat, Bangalore (IN); Ravi Channegowda, Bangalore (IN); Archisman Sarkar, Bangalore (IN)

(21) Appl. No.: 18/777,587

(22) Filed: Jul. 19, 2024

(51) Int. Cl. G05B 13/02; G06F 40/284

(52) U.S. Cl. CPC G05B 13/027; G06F 40/284

(57) ABSTRACT

A system for industrial plant logbook analysis by neural network language model, having a processor, a memory, and one or more programs stored in the memory. The one or more programs comprising instructions configured to receive a logbook of the industrial plant and extract an entity hierarchy flow providing details of hierarchy of various components of the industrial plant, such that the entity hierarchy flow is based on one or more data driven algorithms, design documentation, and a plant context hierarchy document. The system further trains the neural network language model with the entity hierarchy flow, where the training is based on a pretrained language model. The system further receives a user input requesting the industrial plant logbook analysis, such that based on the user input the system calculates a token output of the industrial plant logbook analysis using the trained neural network language model. The system further validates the calculated token output by a generative AI validation layer, updates the token output of the logbook analysis, and displays the updated output of the logbook analysis to the user.

### TECHNICAL FIELD

Present disclosure relates to a system and a method of analysing and reviewing logbooks of plant operations, and particularly, relates to analysis, review, and summarization of the logbooks relating to plant operations based on a tuned neural network language model.

### BACKGROUND

Asset Performance Management (APM) is critical to ensure efficient plant operations and such APM of plants is generally performed based on information recorded in logbooks of plants. Plant logbooks provide relevant information for tracking and handover of plant operations. Logbooks are typically free-text information written by plant operators on a time-to-time basis, and the information recorded in such logbooks includes relevant information relating to process parameter configuration, asset health, and maintenance actions. However, an operator may be expected to review more than hundreds of logbooks and such a manual review of logbooks can cause errors or may lead to missing crucial information.

Therefore, there remains a need for a solution for a real-time and efficient solution for logbook analysis and review.

### SUMMARY OF THE INVENTION

In general, embodiments of the present disclosure herein provide a system and method for real-time and efficient solution for logbook analysis and review based on a tuned neural network language model. Other implementations will be, or will become, apparent to one with skill in the art upon examination of the following figures and detailed description. It is intended that all such additional implementations be included within this description be within the scope of the disclosure and be protected within the scope of the following claims.

In accordance with an embodiment of the present disclosure, an exemplary system for an industrial plant logbook analysis by a neural network language model is provided. The system comprises a processor, a memory, and one or more programs stored in the memory.

The one or more programs comprising instructions configured to receive a logbook of the industrial plant, and extract an entity hierarchy flow providing details of a hierarchy of various components of the industrial plant, such that the entity hierarchy flow is based on one or more of data driven algorithm, design documentation, and a plant context hierarchy document. The one or more programs further comprising instructions configured to train the neural network language model with the entity hierarchy flow, such that the training is based on a pretrained language model, receive a user input requesting the industrial plant logbook analysis, such that based on the user input calculate a token output of the industrial plant logbook analysis using the trained neural network language model. The one or more programs further comprising instructions configured to validate the calculated token output by a generative AI validation layer, wherein the generative AI validation layer is based on one or more rule validations, parameter trend validations, and corroborative AI validations, updates the token output of the logbook analysis based on the validation by the generative AI validation layer and display the updated output of the logbook analysis to the user.

In another embodiment, the present disclosure provides a method for industrial plant logbook analysis by neural network language model. The method comprising receiving a logbook of an industrial plant, extracting an entity hierarchy flow providing details of a hierarchy of various components of the industrial plant, such that the entity hierarchy flow is based on one or more of data driven algorithms, design documentation, and a plant context hierarchy document and training a neural network language model with the entity hierarchy flow, such that the training is based on a pretrained language model. The method further comprises receiving a user input requesting an industrial plant logbook analysis, such that based on the user input: calculating a token output of the industrial plant logbook analysis using the trained neural network language model, validating the calculated token output by a generative AI validation layer, such that the generative AI validation layer is based on one or more of rule validations, parameter trend validations and corroborative AI validations, updating the token output of the logbook analysis based on the validation by the generative AI validation layer and displaying the updated output of the logbook analysis to the user.

In yet another embodiment, the present disclosure provides a non-transitory computer-readable storage medium comprising computer program code for execution by one or more processors of an apparatus, the computer program code configured to, when executed by the one or more processors, cause the apparatus to: receive a logbook of an industrial plant; extract an entity hierarchy flow providing details of hierarchy of various components of the industrial plant, such that the entity hierarchy flow is based on one or more of data driven algorithm, design documentation and a plant context hierarchy document, train a neural network language model with the entity hierarchy flow, such that the training is based on a pretrained language model and receive a user input requesting an industrial plant logbook analysis. Based on the user input: the one or more processors, further cause the apparatus to calculate a token output of the industrial plant logbook analysis using the trained neural network language model, validate the calculated token output by a generative AI validation layer, such that the generative AI validation layer is based on one or more of rule validations, parameter trend validations, corroborative AI validations, update the token output of the logbook analysis based on the validation by the generative AI validation layer and display the updated output of the logbook analysis to the user.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a block diagram of a system for industrial plant logbook analysis by neural network language model, in accordance with an embodiment of the present disclosure;

FIG. 2 illustrates a flow chart of the steps executed for industrial plant logbook analysis by neural network language model, in accordance with an embodiment of the present invention;

FIG. 3 illustrates a block diagram of a system for industrial plant logbook analysis by neural network language model, in accordance with another embodiment of the present disclosure;

FIG. 4 illustrates a flow chart of the steps executed for industrial plant logbook analysis by neural network language model, in accordance with another embodiment of the present invention;

FIG. 5 illustrates a block diagram of a system for industrial plant logbook analysis by neural network language model, in accordance with yet another embodiment of the present disclosure;

FIG. 6 illustrates a flow chart of the steps executed for industrial plant logbook analysis by neural network language model, in accordance with another embodiment of the present invention;

FIG. 7 illustrates a layout architecture of the different components of the proposed system, in accordance with an embodiment of the present invention;

FIG. 8 illustrates a flow chart of the steps executed for fine-tuning of TNNL model based on unsatisfactory outputs of logbook analysis module, in accordance with an embodiment of the present invention; and

FIGS. 9(a) and FIG. 9(b) illustrate a user interface of the proposed system and the

exemplary outputs provided by implementations of the system in response to queries provided by users, in accordance with an embodiment of the present invention.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way that enables one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labelled with the same reference numerals. However, sometimes these elements may be labelled with differing numerals, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components, and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

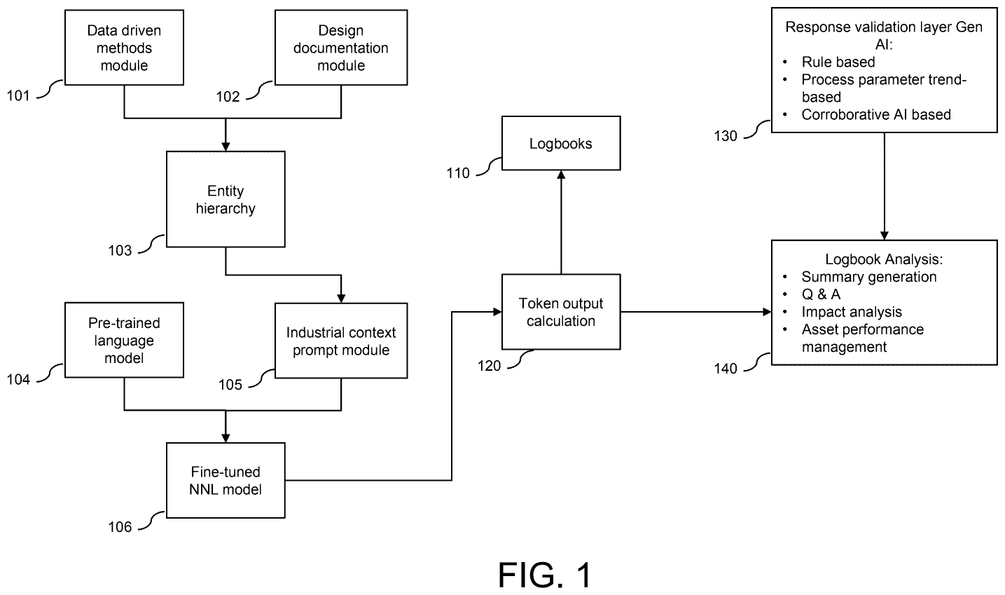

FIG. 1 illustrates a block diagram of a system for a plant logbook analysis by a neural network language model, and validation of the plant logbook analysis, in accordance with an embodiment of the present invention. The implementation of the system 100 proposed in the present invention involves extraction of an entity hierarchy flow of an industrial plant, which provides details of hierarchy of various entities of the industrial plant. The entity hierarchy flow obtained is thereafter used by the system 100 for the tuning a pre-trained neural network language model in the industrial context. The tuned neural network language model may be used for the plant logbook analysis based on a receipt of a user input requesting the plant logbook analysis, and the analysis includes determination of a token output using the tuned neural network language model, and validation of the determined token output by a generative AI validation layer, and updating of the token output based on the validation provided by the generative AI validation layer. The updated output is displayed to the user, such that the output corresponds to the request of the user.

The entity hierarchy flow extracted by the system 100 may be based on one or both of data driven methods module 101 and design documentation module 102. The data driven methods module 101 and the design documentation module 102 provide relevant context and information relating to the relationship between different operations, events, and assets of the industrial plant, and further provide context regarding the functional dependencies and relations between different operations of the plant.

The data driven methods module 101 provides entity hierarchy flow related information which is obtained based on a processing of information relating to sequences of events or alarms by data driven methods or algorithms. The processing of such events may provide insights regarding the relation between different events based on the information relating to the sequences of the events, thereby providing relevant context relating to entity hierarchy flow associated with events in an industrial plant. Hence, the data driven methods module 101 provides relevant insights relating to events in the industrial plant based on the processing of information received from different alarms, sensors, nodes, gauges, etc. associated with one or more operations of the industrial plant.

Design documentation module 102 enables incorporation of operating procedures of the industrial plant or the industry in general, in the extraction of entity hierarchy flow of the industrial plant. The entity hierarchy flow data obtained by the design documentation module 102 may be based on the data relating to the design of plant operations obtained from the plant design documentation, such that the industrial plant design documentation includes drawings, specifications, calculations, manuals, and other records that describe the physical and functional aspects of the plant, essential to the ensuring of safety, efficiency, and compliance of plant operations. Such extensive information relating to the various operating procedures of the industrial plant may be essential in obtaining context regarding the entity flow hierarchy associated with the different operating procedures performed or carried out within the industrial plant.

Hence, the data driven methods module 101 and design documentation module 102 of the system 100 are utilized to obtain processed data related to the entity hierarchy flow of the industrial plant. The information obtained from the two modules contributes to obtaining the context regarding the entity hierarchy flow for training a predefined language model, and the entity hierarchy module 103 of the system 100 is used to extract the entity hierarchy flow of the plant based on the inputs obtained from the data driven methods module 101 and the design documentation module 102. The entity hierarchy flow determined by the entity hierarchy module 103 may be based on the processing of the information obtained from the data driven methods module 101 and the design documentation module 102, and based on a combined processing of the input information obtained from both modules.

Hence, the entity hierarchy module 103 extracts the entity hierarchy flow of the plant based on inputs retrieved from the data driven methods module 101 and the design documentation module 102, and such entity hierarchy flow extracted by the entity hierarchy module 103 may relate to the different operation, assets, and events of the plant, and the entity hierarchy flow extracted by the entity hierarchy module 103 includes by relevant information relating to entity hierarchy flow of the plant such as tag descriptions, linkages, and hierarchy information. Based on the extraction of such features or information associated with the entity hierarchy of the plant, a comprehensive understanding or representation of the hierarchy flow of operations, entities, and assets of the plant is obtained. The extracted entity hierarchy flow is essential for efficiently training a neural network model for analysis and management of operations of the plant, as such hierarchy provides context regarding the relationship between different entity types within the industrial plant. The accuracy of the entity hierarchy flow may be further enhanced based on information obtained from logbooks 110.

The logbooks 110 of a plant are records used for recording states, events, conditions, operations, and repair logs relating to a machinery of a plant or relating to a personnel operating the machinery of the industrial plant, and are generally used in industries and plants for shift communication. In the context of the system proposed in the present disclosure, the logbooks 110 are digital records containing essential information relating to the different operations and events of the plant. The logbooks 110 of the plant may be stored in a database or server directly or remotely connected to the plant and may contain editable logs accessible to employees or operators of the industrial plant. The logbooks 110 are accessed by the system 100 and are essential to address different requirements relating to tasks performed in the previous shift, such as the requirement of a summary of the maintenance tasks performed, information regarding major incidents or equipment failures in the previous shift, information regarding breakdown of different equipment, etc. Hence, the incorporation of such information or data is relevant in enhancing the accuracy of the entity hierarchy flow generated by the system 100.

The logbooks 110 of the plant may be referred to by employees or operators of the plant to obtain relevant information relating to maintenance tasks performed, to obtain records of major incidents and equipment failure, to obtain records of the different equipment inspected in routine inspections, to obtain observations regarding frequency of failure of a specific equipment, to obtain information regarding specific tools or expertise required for repair of an equipment, to obtain details of various safety measure required for different types of repair and maintenance tasks, modifications or upgrade performed during the shift, and actions taken to minimize downtime and maintain production levels. Hence, the logbooks 110 of the plant are essential with respect to obtaining a comprehensive understanding regarding the events of any shift in the plant. The incorporation of data from the logbooks 110 in the extraction of the entity hierarchy flow provides further context regarding the operations and events of the plant based on information recorded in the logbooks and enables more accurate training of the neural network language model.

The tuned neural network model for performing analysis of logbooks of the plant is obtained after the training and fine-tuning of a pre-trained language model 104 in the industrial context, where the pre-trained language model 104 is a language model of general language patterns and features. The pre-trained language model 104 may be pre-trained based on the feeding of a language model with training data comprising general language extending beyond terminologies used in industries and plants, and allowing the model to learn the patterns in the data.

The pre-trained language model 104 is further trained and fine-tuned based on the entity hierarchy flow extracted by the entity hierarchy module 103 to obtain a fine-tuned neural network language model 106. The fine-tuning of the pre-trained language model 104 is based on the tuning data obtained from the processing of entity hierarchy flow provided by the entity hierarchy module 103. The tuning data used for tuning the pre-trained language model to the context of the plant include industrial context relating to the plant, prompts, etc., and are determined by the industrial context prompt module 105 based on the processing of the entity hierarchy flow obtained from the entity hierarchy module 103. Hence, the industrial context and prompt module 105 processes the entity hierarchy flow information provided by the entity hierarchy module 103 to obtain the tuning data.

The fine-tuning of the pre-trained language model 104 for obtaining the fine-tuned neural network language model 106 includes preparing the tuning data obtained from the industrial context and prompt module 105 in a form suitable for tuning the pre-trained language model, wherein the preparation of the tuning data involves tokenizing the text-based tuning data, training a tokenizer for tokenizing the text, and training the pre-trained language model on next-word prediction. The tokenizer is used for processing and cleaning the text dataset to eliminate stop words, punctuation, and other irrelevant information from the text. Tokenizers use natural language processing to split paragraphs and sentences into smaller units, such as words or a group of words, that can be more easily assigned a meaning.

The tokens generated are used for training and fine tuning the pre-trained language model 104 to obtain the fine-tuned neural network language model 106. Such a fine-tuned neural network language model 106 is thereby based on the entity hierarchy flow of the industrial plant. The different steps involved in the training and tuning of the fine-tuned neural network language mode 106 including the extraction of the entity hierarchy flow and creation of tokens corresponding to such hierarchy flow may be performed as an offline scheduled process, and the fine-tuned language neural network model 106 obtained as an outcome of such training and fine-tuning may be implemented for runtime processes of the system, wherein such implementation is based on inputs retrieved from the logbooks for obtaining results and answers to queries raised by the users of the system 100.

The fine-tuned neural network language model 106 is implemented for providing answers to the queries raised by the users of the system 100, based on the analysis of relevant logbooks 110 using the tuned neural network language model 106. Analysis of the logbooks 110 by the tuned neural network language model 106 starts with the token calculation performed at a token output calculation module 120 by the tuned neural network language model 106 with respect to text-based data obtained from the logbooks. The operations performed at the token output calculation module 120 by the tuned neural network language model 106 include the run-time calculation of token probabilities, wherein the tokens are first determined by the tuned neural network language (TNNL) model 106 from the textual data from the logbooks. The TNNL model 106 thereafter calculates the token probabilities of each of the tokens, where the token probabilities indicate the probability value associated with each of the tokens generated or determined by the TNNL model 106 on the logbook data.

The token probabilities obtained by the token output calculation module 120 are used by the TNNL model 106 for performing operations relating to logbook analysis such as logbook summary generation, classification and sentiment analysis, asset performance analytics, impact analysis, questions and answers (Q&A), etc. Such operations are performed by the tuned neural network language model 106 at the logbook analysis module 140, based on the implementation of the tuned neural network language model 106 with respect to an input request provided by the user of the system 100.

For instance, the logbook analysis module 140 performs logbook summary generation of a particular log in the logbooks 110 based on a request raised by the user for the summary of operations and events performed on a specific day. In such an instance, the TNNL model 106 may create the summary of the specific log based on the tokens and corresponding token probabilities associated with the log generated by the token output calculation module 120. In another instance, the user may request a qualitative review of a specific operation or event in the plant, and the review is generated by the logbook analysis module 140 by first performing the summary generation and thereafter performing classification and sentiment analysis on the generated summary. In yet another embodiment, the summary of the logbook may be directly provided to the user.

The classification and sentiment analysis may be performed based on the analysis of the summary for words or groups of words indicative of the sentiment of an individual regarding the quality or satisfaction with an operation of the plant. Analysis of one or more of such words or groups of words provides context regarding the satisfaction or sentiment regarding the quality or productivity of an operation or equipment in the plant, and such an output summarizing the sentiment analysis may be provided as output to the user.

In another instance, the logs maintained by employees in the plant relating to the operation of a specific equipment or operation of the plant may be analyzed by the logbook analysis module 140 using the TNNL model 106 to provide insights regarding the performance of an asset. Such analytics may be performed by the TNNL model 106 based on the statistical data recorded in the logbooks 110 relating to an asset or group of assets and may be performed in response to a request raised by the user. Thus, such different types of analytics performed by the logbook analysis module 140 on data obtained from the logbooks 110 based on the implementation of the TNNL model may be used to address the queries or questions raised by the user relating to different operations and entities of the plant.

The results obtained by the logbook analysis module 140 have a substantial impact on the decisions and actions taken by the user with respect to the operations and events of the plant and thus have a wide-ranging impact on the future performance and productivity of the plant. Hence, due to the significance of the analysis performed by the TNNL model 106 at the logbook analysis module 140, the outputs of analytics performed by the TNNL model are validated by the system 100 to ensure that there is no risky emergent behavior or hallucinations by the TNNL model, and such validation is performed by a response validation layer module 130.

The response validation layer module 130 verifies the results and answers obtained by the logbook analysis module 140 using a generative AI response validation layer. The generative AI response validation layer validates the analyzed output from the logbook analysis module 140 based on reference to other data sources in the plant and actual domain knowledge. The validation may be performed by a plurality of methods including reference to rules, based on process parameter trends, and corroborative AI. For instance, the validation performed by the generative AI response validation layer may be a rule-based validation, wherein the validation involves confirmation as to whether the analysis was performed taking into consideration the rules relating to different operations and assets of the plant.

Further, the validation performed by the generative AI response validation layer at the validation layer module 130 may involve the validation based on process parameter trends. In such a method of validation, the analyzed output is validated by comparison with values or data from parameter trends in identical processes. The validation performed by the generative AI validation layer may also include corroborative validation, wherein the analyzed output may be corroborated with outputs analyzed for similar queries of the user in previous instances of implementation of the system 100.

Based on such type of validations performed at the validation layer module 130, the output or results provided by the system 100 to the users may vary, such that the variation may include simply the output of the logbook analysis module 140, an output combining the results of the logbook analysis module 140 and the validation layer module 130, or simply the validated output obtained from the validation layer module 130. In an embodiment, the output may be the output analyzed by the logbook analysis module 140 along with a metric such as a percentage value or score indicating the level of reliability of the output, wherein the value of such a metric is assigned based on the results of validation performed by the generative AI response validation layer 130.

In another embodiment, if the result of the validation performed by the validation layer module 130 indicates that the logbook analysis of the logbook analysis module 140 is incorrect, the system 100 may provide an error message to the user. In certain embodiments of the present invention, the output of the logbook analysis module 140 may be provided as output to the users, and the users may choose whether further validation of the output is to be performed by the system 100, and based on such a choice of validation, the system 100 may perform the validation of the analyzed output based on the implementation of the generative AI response validation layer 130.

The tokens, data, intermediary results, and final results obtained during the analysis of the logbooks 110 and the validation of the analysis may be subsequently used for further tuning the TNNL model 106. Such information may also be stored in the logbooks 110 for future reference or may be stored in a database for future reference or corroboration by the validation layer module 130. The results obtained by the logbook analysis module 140 and the validation layer module 130 may also be used for rectifying any inaccurate or incorrect entries in the digital logs of the logbooks 110.

Hence, the system 100, on receiving an input query or question from a user or individual associated with the plant, may perform analysis of the logbooks 110 of the plant based on the implementation of a TNNL model 106, wherein the TNNL model 106 is obtained based on the training and tuning of a pre-trained language model 104 with tokens corresponding to the entity hierarchy flow of the plant. Such a tuning is performed to train the model in the context of the plant, and the different language patterns associated with or used in the plant, and to enhance the performance of the model with regard to the internal hierarchy and relation of different operations, assets, and equipment of the plant.

The TNNL model 106 may be developed prior to the execution of run-time processes of the system relating to analysis and validation and may be implemented for performing analysis of logbooks 110 in order to address the user queries. The analysis performed by the TNNL model 106 may return answers to the queries or questions raised by the user, and such answers may be either directly provided to the user or may be provided after validation by the generative Al validation layer. The data and output generated during the analysis and validation processes may be subsequently used for further tuning the TNNL model 106 for future executions of the system 100.

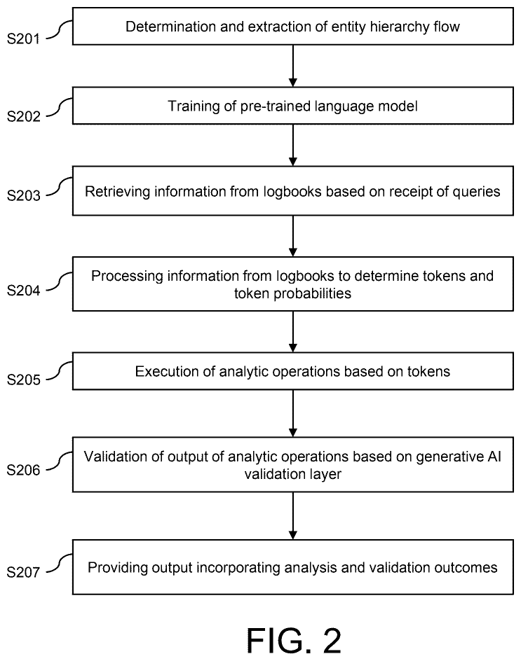

FIG. 2 illustrates the steps executed by the system for plant logbook analysis and validation of analysis, in accordance with an embodiment of the present invention. Firstly, at step S201, an entity hierarchy flow of the plant is determined. Step S201 involves the extraction of the entity hierarchy flow of the plant based on the execution of data driven methods, and retrieval of information based on the design documentation of the plant. The data driven methods relate to different methods for processing different types of data relating to or associated with the plant, where such data is obtained from the different sensors and alarms of the plant. Processing of such data is relevant for determining the relation between different operations, assets, and equipment of the plant, and thereby obtaining context regarding the entity hierarchy flow of the plant.

The design documentation relating to the plant may also be processed at step S201 for incorporating the operating procedures of the plant. The design documentation of the plant includes data such as drawings, specifications, calculations, manuals, and other records relating to the safety and compliance requirements of the plant. Processing of such data performed at step S201 ensures that such essential information is incorporated in the entity hierarchy flow extracted. In addition to the extraction of entity hierarchy flow based on the design documentation of the plant and the execution of data driven methods, step S201 also includes the incorporation of relevant information from the logbooks of the plant. Such incorporation of information from the logbooks into the entity hierarchy flow will ensure further precision of the data used for training a pre-trained language model.

After the extraction of information relating to the entity hierarchy flow of the plant, the entity hierarchy flow is thereafter used for training of the pre-trained language model at step S202. The training of the pre-trained language model performed at step S202 involves the processing of the entity hierarchy flow obtained after execution of step S201 to obtain training-ready data, wherein the training-ready data incorporates context regarding the entity hierarchy workflow into the training and tuning of the pre-trained language model. The training-ready data obtained thereby are tokens corresponding to the entity hierarchy workflow, and the tokens are obtained based on the implementation of a trained tokenizer. Based on such training and tuning performed in step S202, a fine-tuned neural network language model is obtained.

Steps S201 and S202 may be executed as offline processes prior to the run-time processes which include the analysis of the logbooks and validation of the analysis. In certain embodiments of the present invention, the fine-tuning of the tuned neural network language model performed in step S202 may be performed continuously based on the availability of new information relating to entity hierarchy flow or new data recorded in the logbooks of the plant. Such a continuous tuning of the tuned neural network language model enables enhanced performance and accuracy of the model.

Based on the tuned neural network language (TNNL) model obtained at step S202, the analysis of logbooks may be performed by the TNNL model based on the receipt of a query or question from a user, wherein the query or question raised may relate to logs recorded during a specific shift of the plant, or may be associated to an operation, asset or equipment of the plant. The query raised by the user may also be regarding the repairs, maintenance, and inspections performed for a specific equipment or performed in a specific time period.

The queries of the user may also be related to requests for certain functionalities such as the generation of a summary of one or more logs in the logbook, providing results relating to the performance of specific assets of the plant, and providing an analysis of the sentiment or satisfaction associated with performance of a particular equipment or operation of the plant. The users may also request an analysis of the logbooks to obtain information relevant to the shift handover process which includes information regarding permit to work status, alarm defeat logs, emergency shutdown device (ESD) defeat logs, controller mode status, sample logs such as lab results, defective equipment log, night order book, unit and factory standing instructions/orders, work order log, shutdown job folders, material handling guides, and production, operations, and safety incident logs.

Step S203 includes receiving the queries raised by the users, and retrieving information relevant to addressing such queries. Information relevant to addressing such queries and questions of the user may be obtained in the logs recorded in the logbooks by different employees and managers of the plant, and analysis of such information stored in the logbooks in order to provide requisite output to the users. In certain embodiments of the present invention, the queries may be provided by users as a text-based question, and the step S203 performed by the system may include the processing of the input query or question provided by the user based on the TNNL model, and accessing of the relevant logs in the logbooks of the plant based on such processing.

After the relevant information has been retrieved from the relevant logs of the logbooks based on the receipt of a query or question by the user at step S203, the next step performed is S204 relating to the processing of the information received from the logbooks. The step S204 includes the processing of the relevant logs by the TNNL model, and extraction of a plurality of relevant tokens from the accessed logs of the logbooks based on the query provided by the user. The tokens generated or extracted by the TNNL model correspond to units of natural language that can be assigned a meaning. The tokens created may be words or a group of words and are obtained based on the deconstruction of the natural language data stored in the logs, which are generally in the form of sentences or paragraphs. The step S204 also includes the calculation of token probabilities of each of the tokens by the TNNL model, where the token probabilities are indicative of the probabilistic values associated with each of the tokens generated from the data obtained from the logbook. The token probability indicates the probability for a particular token based on previous tokens. The calculation of token probabilities at step S204 is useful in determining tokens that have a high probability of being associated or used along with a specific token, and is thereby indicative of relation between tokens.

After the tokenization and calculation of token probabilities by the TNNL model in step S204, the next step performed is S205 which involves the execution of various analytic operations based on the tokens created at step S204. The analytic operations performed at step

S205 are based on the specific requirements provided in the query or question raised by the users, and the analytic operations that may be performed at step S205 include, but are not limited to, summary generation, classification and sentiment analysis, asset performance analysis, and impact analysis. The summary generation operation may be performed in step S205 in response to a user request for a summary of one or more logs in a logbook relating to a specific shift, event, operation, or equipment of the plant.

The classification and sentiment analysis operation which may be performed in step S205 includes the generation of summaries of one or more logs of the logbook relating to a specific shift, event, operation, or equipment of the plant, and analyzing such summaries for determining the sentiment or classification expressed in such summaries regarding the quality or performance of such shift, event, operation, or equipment of the plant. The sentiment and classification analysis are based on processing a qualitative measure of performance or satisfaction associated with an aspect of the plant, which may be expressed or indicated by the language pattern or tokens determined at step S204 corresponding to the data retrieved from the logbooks. Analysis performed in step S205 may also include asset performance analysis, which includes processing of the statistical data obtained from the relevant logs of a logbook for providing an indication or assessment regarding the performance of the asset.

The results of the analysis performed in step S205 are validated at step S206 by the generative AI response validation layer. The validation by the generative AI layer contributes to risk assessment and mitigation strategies for the validation of results obtained based on the implementation of the TNNL model, where the validation may be based on analyzing data patterns in other data sources and actual domain knowledge, and historical data relating to previous analysis performed by the TNNL model. The validation performed in step S206 may be based on one or more of a plurality of validation methods including reference to rules, based on process parameter trends, and corroborative AI. The validation with reference to rules that may be performed in step S206 includes the confirmation of whether various rules relating to the plant are taken into consideration during the analysis of the logbooks at step S205.

Further, the validation based on process parameter trends that may be performed by the generative AI in step S206 includes the validation of the analyzed output obtained by the TNNL model at step S205 based on a comparison with values or data from parameter trends in identical processes that may have been performed in the plant. The validation based on process parameter trends performed at step S206 may also be based on a comparison with results obtained by the TNNL model in prior executions of the system for the same or similar query raised by the users, wherein the results obtained in such prior executions may be stored in the memory or database for future references.

Based on the outcome of the validation performed in step S206, the system may provide an output to the query or question raised by the user at step S207. The result provided at step S207 may be either the result obtained after validation, the result obtained after analysis along with an indication regarding the accuracy of the output, wherein the indication regarding accuracy may be provided according to the validation output, or may be a combination of the results obtained by the analysis and the validation. Step S207 may also include actions such as saving of the outcomes for future reference, and making amendments to the logbooks based on the errors determined during the analysis or validation processes.

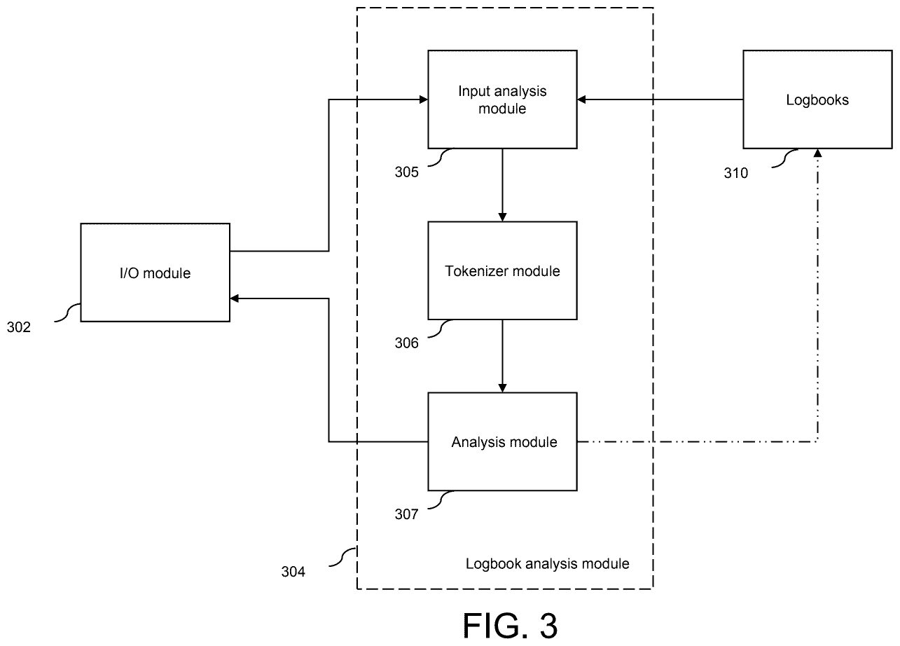

In an exemplary embodiment of the proposed invention, the system may be used for providing an output corresponding to a query or question raised by the user, wherein the system comprises only modules for creating tokens from information stored in logbooks and generating output based on analysis performed on such tokens. The system proposed in such an exemplary embodiment does not comprise modules relating to the generation of a TNNL model or modules relating to the validation of the analysis performed using the tokens. FIG. 3 illustrates such a system for performing analysis of logbooks, in accordance with an embodiment of the present invention.

The system 300 comprises an I/O module 302, a logbook analysis module 304, and the logbooks 310. The I/O module 302 is used for retrieving one or more queries or questions from the users of the system 300, and for returning results corresponding to the queries or questions based on an analysis performed by the logbook analysis module 304. The logbook analysis module 304 further comprises an input analysis module 306, a tokenizer module 307, and an analysis module 308, and uses a fine-tuned TNNL model for performing analysis on logbook information for obtaining results for the queries raised by the users. The TNNL model used by the system 300 is a TNNL model that has already been trained and fine-tuned, and is implemented by the logbook analysis module 304 of the system 300.

The one or more input queries raised by the user are retrieved by the input analysis module 306 of the logbook analysis module 304 from the I/O module 302. The input queries retrieved are first analyzed by the input analysis module 306 to determine the type of information that is required to provide the requisite output to the input queries. The analysis of the input queries may be performed by the TNNL model to determine the requisite information for the analysis, based on which specific logs of the logbooks 310 may be accessed by the input analysis module 306 to obtain the required information. In certain embodiments, the analysis of the input query provided by the users may be performed by a natural language processing (NLP) model, or the TNNL model may be assisted by a NLP model in the analysis.

The input analysis module 306 thereby performs the necessary actions relating to preparing the information using which the analysis is performed to provide the output. The information recorded in the logs accessed by the input analysis module 306 is thereafter tokenized by the tokenizer module 307 of the logbook analysis module 304, wherein the tokenizer module 307 performs the action of tokenizing the text-based information stored in the accessed logs. The tokens created by such an action constitute the smallest meaningful units of information that can be obtained from textual data, which may be words or a group of words.

The tokens created by the tokenizer module 307 are thereafter assigned token probability values by the tokenizer module 307. The calculation of token probabilities is performed by the TNNL model and is performed to assign values relating to the probability of a token in a particular context or sentence.

The generation of tokens and the calculation of token probabilities performed by the TNNL model in the tokenizer module 307 is thereafter used in the analysis module 308 to perform various functionalities of the logbook analysis module 304 such as summarizing a log, determining asset performance analytics, performing impact analysis etc. The tokenization of the information and calculation of the token probabilities enables the TNNL model in performing language processing operations required for performing such functionalities, and the output obtained corresponding to such functionalities is provided as output to the users using the I/O module 302. In some implementations of the system 300, the functionalities performed by the analysis module 308 may be one or more of the different functionalities such as summary generation, impact analysis asset performance, etc. In addition to providing the output generated by the analysis module 308 to the users based on the I/O module, the results may also include analysis relating to values or information corresponding to an operation of the plant that was incorrectly recorded in the logbooks, and the analysis module 308 may also perform necessary corrections in the logbooks 310 based on such analysis.

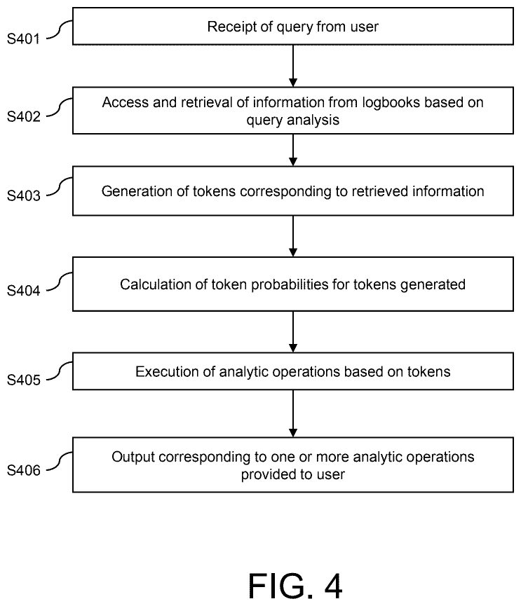

FIG. 4 illustrates a flowchart of the steps executed by a system for performing analysis of logbooks, in accordance with an embodiment of the present invention. Step S401 involves the receipt of one or more input queries or questions raised by a user relating to operations or assets of the plant using the I/O module. The input queries may be provided as sentences formulated in natural language and may include terminologies or words associated with the plant. Alternatively, the input queries may be pre-defined and may be selected from a drop-down menu. The input query is analyzed by the input analysis module at step S402 so as to determine the types and volume of information required for analysis so as to provide the required output. The input query analysis performed at step S402 is based on processing of the input query by the TNNL model.

Based on the analysis of the input query by the TNNL model, the relevant information stored in logbooks of the plant is also accessed and retrieved in step S402. The information retrieved from the logbooks is text-based data which may be in the form of sentences or paragraphs that are complex in nature, thereby increasing the complexity of the analysis to be performed based on such information. Hence, tokens are generated at step S403 corresponding to such information for case of analysis, and such tokenization is performed based on the implementation of the TNNL model. Step S404 involves the calculation of token probabilities corresponding to the tokens generated at step S403, and such token probabilities enable the analytic operations performed by the analysis module, including the prediction of the next word.

Based on the tokens generated in step S403 and the token probabilities determined at step S404, different analytic operations for providing requisite outputs are performed at step S405. The different types of analytic operations performed at step S405 include the generation of summaries based on information contained in logbooks, wherein the summary generated may relate to events of the plant in a particular shift, operations performed by an asset or equipment of the plant, repair, and maintenance history of a particular equipment, etc. The analytic operations performed at step S405 may also include asset performance analytics, generating answers to questions raised by the user, and impact analysis. The output generated by the logbook analysis module corresponding to analytic operations performed at step S405 may be a combination of the different analytic operations performed by the logbook analysis module, depending upon the query raised by the user. The output is provided to the user at step S406 using the I/O module of the system.

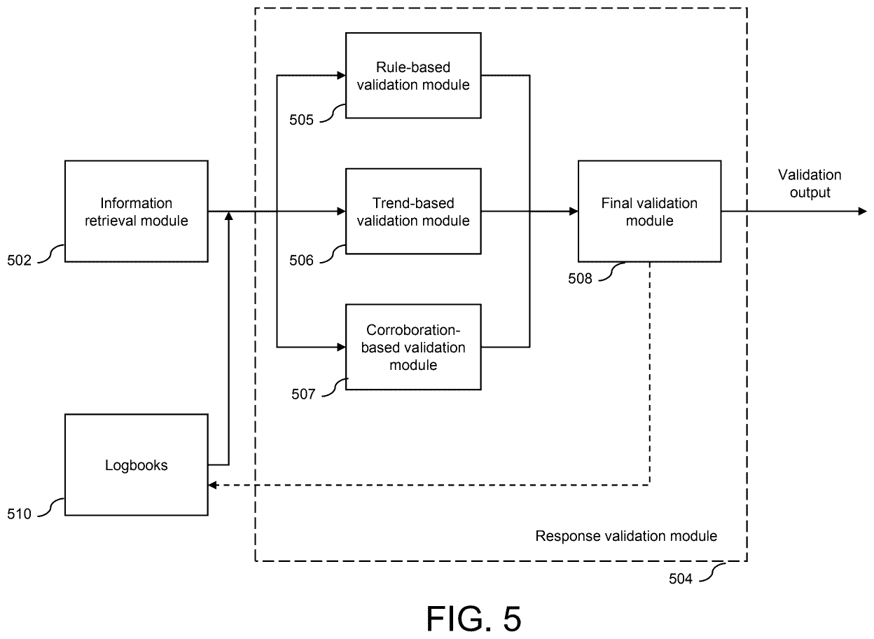

In certain exemplary embodiments of the present invention, the validation of the results obtained by the analysis of logbooks may be performed as an independent process based on implementation of an independent system. Such an implementation is beneficial in scenarios where the analysis of logbooks is performed manually or by some other processing and analytics methods or tools, and requires further validation. FIG. 5 illustrates such a system for performing validation of results of a logbook analysis, in accordance with an embodiment of the present invention. The system 500 for performing validation of the results of a logbook analysis can be implemented for validating the analysis of logbooks performed by TNNL model or for validating the analysis performed by any other analytics tool or method. The validation performed by the system 500 comprises an information retrieval module 502, a response validation module 504, and logbooks 510. The retrieval module 502 of the system 500 is used for retrieval of all necessary information for the validation of the analysis, including the outputs obtained during analysis, the information used for obtaining the analysis output, the different rules relating to the plant and its operations, actual knowledge relating to the domain, parameters relating to the operations of the plant etc. Retrieval of such information may involve accessing databases, logbooks 510, repositories of previous analysis etc.

After retrieving necessary information for the validation of the analysis output based on implementation of the information retrieval module 502, the response validation module 504 is used for validating the logbook analysis outputs. The response validation module 504 further comprises a rule-based validation module 505, a trend-based validation module 506, a corroboration-based module 507, and a final validation module 508. The rule-based validation module 505 is used for performing validation of the logbook analysis output based on the different rules that are applicable to the plant, and verifying if the analysis is performed in accordance with the requirements stated in the rules.

The trend-based validation 506 is used for performing process parameter trend validation based on similar trends relating to process parameters that are observed or determined for similar operations or events of the plant for which logbook analysis was performed. Information relating to such trends may be derived from the previous logs in the logbooks 510 of the plant, or from process parameters of similar operations that may be generally known or accessible by the information retrieval module 502.

The corroboration-based module 507 of the response validation module 504 is used for corroborating the output of the logbook analysis with outputs obtained corresponding to the same or similar queries in previous iterations of logbook analysis or validation. The data relating to the previous iterations of logbook analysis may be stored in a repository, database, or even as logs in the logbooks 510, and are accessed by the information retrieval module 502 based on the query for which logbook analysis was performed.

Implementation of the rule-based validation module 505, the trend-based validation module 506, and the corroboration-based module 507 are performed based on a generative AI response validation layer, wherein the generative AI layer helps in performing evaluations to guarantee the precision, inclusiveness, and coherence of the logbook analysis output with respect to rules, parameter trends, and previous outcomes of analysis and validation.

The validation operations performed in the rule-based validation module 505, the trend-based validation module 506, and the corroboration-based module 507 of the response validation module 504 based on the implementation of the generative AI is thereafter aggregated by the final validation module 508 to obtain a final validation of the logbook analysis. The aggregation by the final validation module 508 is performed using the generative Al technologies, and the aggregation involves the incorporation of the outputs of validation performed by various modules.

The output of the final validation module 508 may be provided to the user of the system 500, and the output may be in the form of an indication regarding the accuracy of the logbook analysis compared to the validated output obtained from the response validation module 504. The response validation module 504 may also make necessary changes to the information recorded in the logs of the logbooks 510 based on the validated results. For an exemplary implementation of the system 500, the logbook analysis to be validated may be a summary generated corresponding to events of a particular shift. The validation performed by the response validation module 504 may include validation based on rules relating to shifts, parameter trends generally observed for shifts on that particular day of the week, and data relating to the prior history of shift. The output to the user by the response validation module 504 may be an estimated accuracy of the logbook summary.

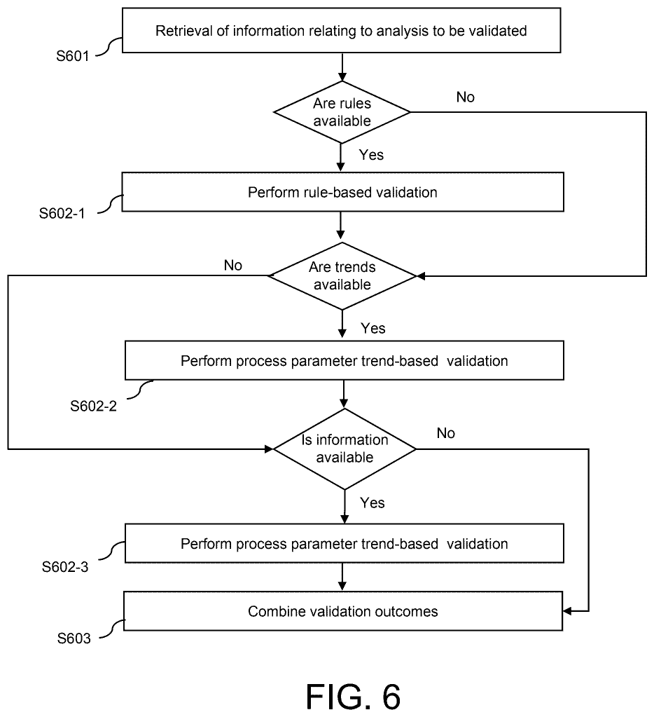

FIG. 6 illustrates a flowchart of the steps performed by a system for performing validation of logbook analysis, in accordance with an embodiment of the present invention. Step S601 performed by the system involves retrieving relevant information relating to the analysis for which validation is to be performed, wherein the relevant information includes the results of the analysis, inputs used for the analysis, information stored in logbooks of the plant etc. Once the information relating to the analysis to be validated is retrieved, a rule-based validation of the output of the analysis is performed at step S602 if relevant information relating to the rules of the plants are available.

Step S602-1 involves retrieving the relevant rules, and performing validation based on the retrieved rules, wherein the validation determines if the analysis was performed taking into consideration all with applicable rules relating to the plant and its operations. Such a validation is performed by a generative AI layer. If the relevant rules are not available to the system, step S602-1 is not performed and the process moves on to the next step.

Thereafter, process parameter trend-based validation is performed at step S602-2, subject to the availability of necessary information relating to the process parameter trends. If sufficient information is available, process parameter trend-based validation is performed, wherein such validation is performed by a generative AI validation layer and involves the analysis of comparable or similar process parameter value trends that are observed in the plant. If the relevant information relating to process trends is not available to the system, step S602-2 is not performed and the process moves on to the next step.

Thereafter, the corroborative AI-based validation is performed at step S602-3 subject to the availability of necessary information for corroborating the results of the analysis. The validation is performed by the generative AI validation layer and involves the corroboration of the output of the analysis with relevant information such as actual knowledge, historical data relating to the plant, etc. If the relevant information for corroboration is not available to the system, step S602-3 is not performed and the process moves on to the next step.

The outcomes of the different types of validation performed in one or more of steps S602-1, S602-2, and S602-3 are combined to obtain the final validation at step S603 of the analysis, and the final validation may be used to indicate the accuracy of the analysis performed, for providing the users with an alert signaling possible incorrect results provided during analysis of logbooks, and for rectifying any incorrect/inaccurate data stored in logbooks.

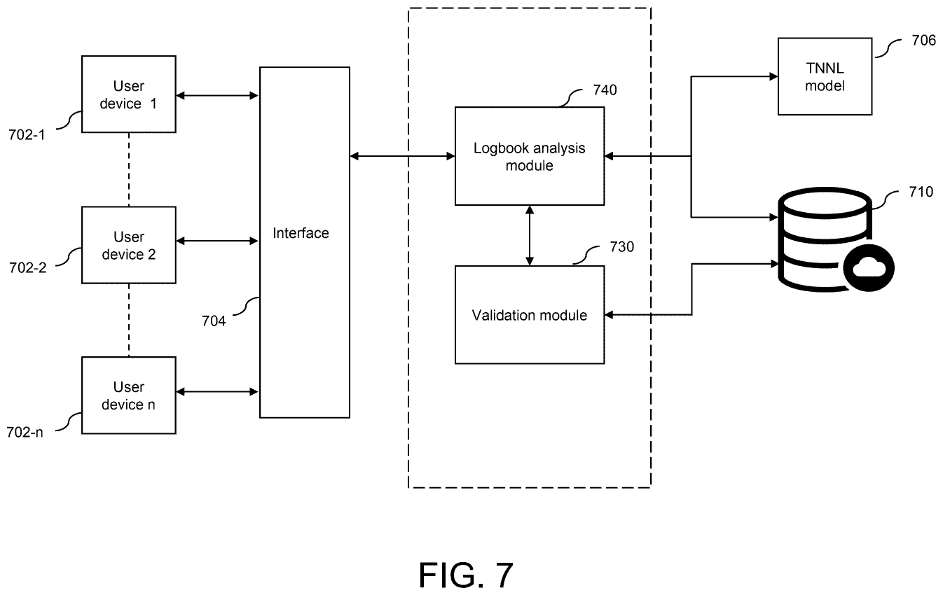

As per an embodiment of the present disclosure, the implementation of the logbook analysis and the response validation by the TNNL model is initiated based on the receipt of an input query from one or more users. FIG. 7 illustrates a layout architecture of the different components of the proposed system, in accordance with an embodiment of the present invention. The system 700 receives as input from one or more users a query or question relating to a logbook analysis that is to be performed. The users may be an employee or manager of the plant for which the system 700 is implemented, and the query or question may relate to different requirements of the user such as the need of a summary of operations performed on a specific day, information regarding to recent repairs, analysis of the performance of assets of the plant, Questions and Answers with the logbook, etc.

The input may be retrieved from the users by means of user devices 702 such as a computer, laptop, etc. The input may be provided as a text-based query generated by the user or may be selected from a set of pre-defined queries generally raised in the plant or industry. The input is provided to the logbook analysis module 740 by means of an interface 704. The interface 704 ensures the portability of the proposed system, wherein the user devices 702 may not be directly connected to the module or server used for the implementation of the logbook analysis and response validation performed by the a TNNL model 706. The interface 704 provides the queries obtained from the input devices 702 to the logbook analysis module 740, and the logbook analysis module 740 performs the analysis of information stored in the logbooks 710 based on implementation of the TNNL model 706.

The TNNL model 706 is obtained by the system 700 based on training of a pre-trained data model on entity hierarchy flow context. The entity hierarchy flow context is obtained based on the data driven methods and design documentation of the plant and is also based on the information obtained from the logbooks 710 of the plant. The entity hierarchy flow is obtained based on such methods and information and is further processed to obtain tokens for fine-tuning the pre-trained language model. The fine-tuning of the pre-trained language model helps obtain the TNNL model 706, and such training and tuning are performed prior to run-time operations of the system 700. In certain embodiments of the present invention, the TNNL model 706 is pre-trained, and the training and tuning of the TNNL model 706 is not performed by the system 700. Further, in other embodiments of the present invention, the fine-tuning of the TNNL model 706 is continuously performed by the system 700.

The logbook analysis module 740 performs analysis of the logbooks by the system 700 in order to provide a response to the query or questions retrieved using the interface 704. The logbook analysis module 740 initially performs an analysis of the query or question raised by the user, and based on such analysis, accesses the logs of the logbooks 710 to retrieve information requisite for the analytic operations to be performed. The information that is retrieved from the logbooks 740 by the logbook analysis module 740 is thereafter tokenized by the TNNL model 706, wherein the tokenization is performed for case of performing analytics operations. The TNNL model 706 also performs the calculation of probabilities of tokens generated corresponding to the information accessed from the logbooks, and analytic operations are performed by the analysis module 740 based on the tokens and their calculated probability values.

The analytic operations performed by the logbook analysis module 740 using the TNNL model based on tokens and token probabilities generated corresponding to information recorded in logbooks 710 include summary generation, asset performance analytics, answering questions, and impact analysis. The result obtained based on such analytic operations performed by the TNNL module 706 may be provided to the users as output through the interface 704 at the user devices 702. In certain embodiments, the system 700 performs validation of the result obtained by the logbook analysis module 740.

The validation of the output of the logbook analysis module 740 is performed by the validation module 730, wherein a generative AI validation layer is used for validating the accuracy of the output of the logbook analysis module 740. The generative AI performs one or more of rule-based validation, process parameter trend-based validation, and corroboration-based validation for verifying the correctness of the analyzed output. As per some embodiments of the present invention, the output of the validation may be provided independently to the user via the interface 704 at the user devices 702. In other embodiments, the results of the validation module 730 may be provided back to the logbook analysis module 740, and the logbook analysis module 740 provides the results obtained by the analysis as the output to the user device 702 via the interface 704 along with an indication of estimated accuracy of the analysis, such that the estimated accuracy is calculated based on comparison of the analysis output with the validation output. In other embodiments of the present invention, the output of the validation module 730 is provided as the output at the user devices 702.

In certain embodiments of the present invention, the analytics operations performed by the logbook analysis module 740 and the validation performed by the validation module 730 may involve the correction of incorrect information recorded in the logbooks 710 of the plant. The corrections made to the information stored in the logbooks 710 of the plant by the analysis module 740 and/or the validation module 730 include corrections in the spelling, grammar, short forms etc. of the text-based information stored in the logbooks 710. In other embodiments, the outcomes of implementations of the logbook analysis module 740 and the validation module 730 may be stored in the memory, database or repository for reference of future iterations of the analysis and validation processes of the system 700.

The TNNL model 706 used by the analysis module 740 may be trained and tuned offline, prior to the run-time operations of the system 700. In certain embodiments of the present invention, the TNLL model 706 may be constantly and continuously updated and fine-tuned based on additional information that may be entered into the logbooks, outputs obtained by the logbook analysis module 740 and the validation module 730, based on the determination of erroneous output obtained by the analysis module 740, or based on a combination of such factors. In embodiments where TNNL model 706 is fine-tuned based on unsatisfactory or incorrect output of logbook analysis module 740, the determination of an unsatisfactory output of the logbook analysis module 740 may be made based on comparison with the output obtained by the validation module 730. The fine-tuning of the TNNL model 706 is such embodiments may be automated based on detection of such unsatisfactory outputs of the logbook analysis module 740. The determination of the erroneous output or analysis performed by the analysis module 740 may be made based on comparison with the output or validation obtained by the validation module 730.

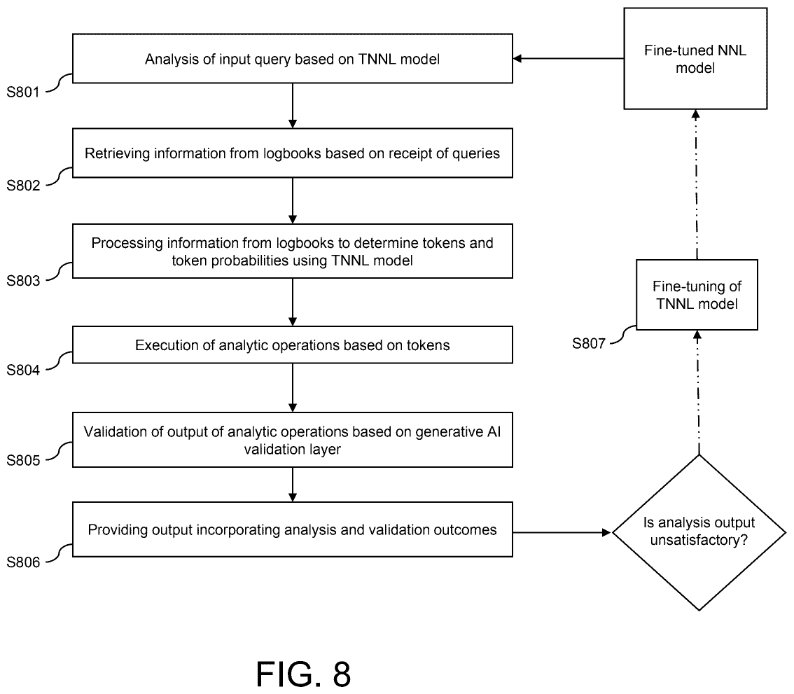

FIG. 8 illustrates a flowchart of steps performed that includes fine-tuning of a TNNL model based on unsatisfactory outputs of a logbook analysis module, in accordance with an embodiment of the present invention. The process may be initiated by the receipt of a user request. Step S801 involves the analysis of the input query provided by the user based on the TNNL model. The TNNL model may be obtained based on the training of a pre-trained language model in the context of the entity hierarchy workflow of the plant in case of initial implementation of the system, or may be the TNNL model obtained after last instance of fine-tuning performed.

The analysis of the input query performed by the TNNL model at step S801 is thereafter used in step S802 to retrieve relevant information from the logbooks of the plant. The information extracted from the logbooks are thereafter processed in step S803 by TNNL model to obtain tokens corresponding to the information, wherein the token is the smallest unit of meaningful data that can be generated or obtained from the logbook information. The processing performed by the TNNL model at step S803 also includes the calculation of token probabilities.

The tokens and token probabilities determined in step S804 are thereafter used for performing analytic operations such as summary generation, generating natural language-based answers to questions of users, providing updates regarding status of an operation, etc. by the logbook analysis module at step S804. The output of the logbook analysis module is validated by the validation module at step S805 using a generative AI, wherein the validation performed may include one or more of corroborative AI based validation, process parameter trend-based validation, and rule-based validation.

The implementation of the logbook analysis module at step S804 and the validation module at step S805 may also involve making corrections in the information recorded in the logbooks of the plant. The changes made to the logs may include corrections of spelling or grammar, incorrect data, etc. The output of the analytic operations performed by the logbook analysis module at step S804 and the output of the validation of the analysis outputs by the validation module performed at step S805 may be used to provide an output to the user at step S806. The output may be the output of the logbook analysis module along with an indication regarding the estimated accuracy of the output wherein the estimated accuracy is determined based on a comparison of the analysis output with the output of the validation module. In other embodiments, the output may be the output of the validation module.

If the comparison of the output of the logbook analysis module with the output of the validation module shows a significant difference, such a difference may be indicative of the lack of accuracy of the TNNL model used in the implementation of the logbook analysis module. Such a result wherein the output of logbook analysis module is significantly different to the output of the validation module can hence be considered to be an unsatisfactory output, and in such circumstances, step S806 is followed by step S807 wherein the TNNL model used in the logbook analysis module is further fine-tuned based on data including additional data from logbooks, the output of the validation module, etc. Such a fine-tuned TNNL model will thereafter be used in the next implementation of the system.

In certain embodiments of the present invention, a threshold may be set for the level of similarity of the outputs of the logbook analysis module and the validation module, and the threshold may be used to decide if the output of the logbook analysis module is unsatisfactory to the extent of triggering the fine-tuning of the TNNL model. Such a conditionality-based implementation of the tuning of the TNNL model used in the analysis of logbook information is beneficial as it reduces the processing load of continuous fine-tuning while ensuring that the TNNL model is accurate.

The system comprising the logbook analysis module and the validation module used for providing the users of the system with efficient means of addressing their queries and questions relating to the operations, events, and assets of the plant, based on information accessed from the logbooks of the plant. The questions or queries that may be generally raised by the users include questions relating to maintenance tasks performed in previous shifts such as:
a) Can you summarize the types of maintenance tasks that were performed during these shifts?
b) Were there any major incidents or equipment failures that occurred during these shifts?
c) What types of equipment were inspected during routine inspections?
d) Did the night shift encounter any unique challenges or issues compared to the day shift?
e) Can you provide a breakdown of the types of equipment that were checked during the various shifts?
f) Were there any patterns or trends in the types of malfunctions that were reported?
g) Did any of the repairs require specialized tools or expertise?
h) What steps were taken to ensure the safety of the operators during the repairs and maintenance tasks?
i) Were any modifications or upgrades made to the equipment during these shifts?
j) What actions were taken to minimize downtime and maintain production levels?

The analysis and validation performed by the proposed system allow to provide requisite responses to such queries that may be raised by the users, based on the analysis of information stored in an industrial plant logbook relating to the shifts of the plant using the TNNL model, and validation of the analysis using the generative AI validation layer. The proposed system may also be able to provide a conversational thread relating to the workflow of the plant in a manner as provided below:
1) What is the level of the Flux Oil Make Up in refinery tank?
   a) Flux oil make up from refinery tank level is 89%.
2) Why is the flux oil level so low?
   a) 911-PA-1201D supposed to fill with flux oil, but this is not working due to seal fluid leakage in NDE side. On the DE side, there is a mismatch in the offsite and actual reading.
3) How was the seal fluid leakage caused?
   a) There is a mechanical failure in the pump seal.
4) What is the contingency plan to correct this failure?
   a) Permit issued to instrument for DE side to account for the reading mismatch.

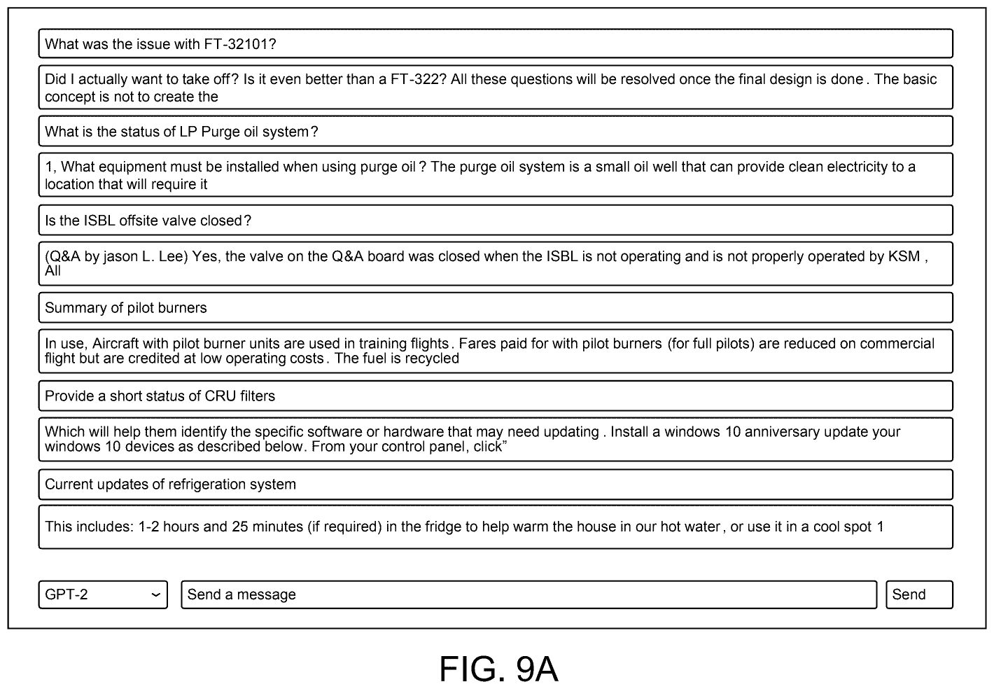

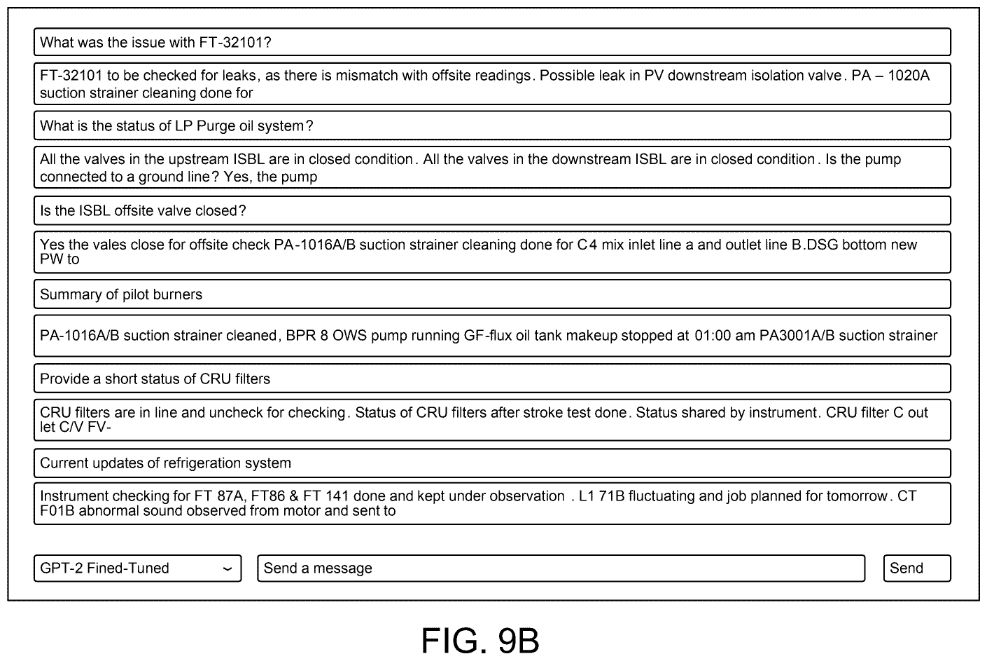

FIGS. 9(a) and FIG. 9(b) illustrate a user interface of the system and the exemplary outputs provided by implementations of the system in response to queries provided by users, in accordance with an embodiment of the present invention. The user interface provided at the user devices may include a text box by means of which the user may provide a query. The response may be provided in the user interface as illustrated in FIGS. 9(a) and 9(b), wherein the response may be an answer to the query comprising the outcome of the analytic operations, a summary or short status, updates of a particular equipment or group of equipment, etc. The user may access his user interface and the instructions provided by the user are provided as input to the system. The user input may be provided to a processor which is connected to the memory. The processor may be a part of the user device. Alternatively, the processor may be part of a separately installed machine. Based on the user inputs sent to the processor, the user interface may be updated based on instructions received from the processor based on instructions stored in the memory.

In an embodiment, standard user inputs may be stored within the memory of the processor, and may be referred to for providing interactive user interface. The processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein. The processor may be configured to execute instructions stored in the memory or otherwise accessible to the processor. Alternatively, the processor may be configured to execute hard-coded functionality. As such, whether configured by hardware or software methods, or by a combination thereof, processor may represent an entity (e.g., physically embodied in circuitry) capable of performing operations according to embodiments of the present disclosure while configured accordingly. Alternatively, the processor may be embodied as an executor of software instructions, and the instructions may specifically configure the processor to perform the various algorithms embodied in one or more operations described herein when such instructions are executed. In some embodiments, the processor includes hardware, software, firmware, and/or a combination thereof that performs one or more operations described herein. In some embodiments, the processor (and/or co-processor or any other processing circuitry assisting or otherwise associated with the processor) is/are in communication with the memory via a bus for passing information. Memory may be non-transitory and may include, for example, one or more volatile and/or non-volatile memories. In some embodiments, the memory includes or embodies an electronic storage device (e.g., a computer readable storage medium). In some embodiments, the memory is configured to store information, data, content, applications, instructions, or the like, for enabling processor to carry out various operations and/or functions in accordance with example embodiments of the present disclosure.

Specific input instructions provided by a user for registration of a software application may also be based on use of specific input/output unit. The input/output unit may be in communication with the processor. The input/output unit may comprise one or more user interface(s). In some embodiments, a user interface may include a display that comprises the interface(s) rendered as a web user interface, an application user interface, a user device, a backend system, or the like. In some embodiments, the input/output unit also includes a keyboard, a mouse, a joystick, a touch screen, touch areas, soft keys a microphone, a speaker, or other input/output mechanisms. The processor and/or input/output unit comprising the processor may be configured to control one or more operations and/or functions of one or more user interface elements through computer program instructions (e.g., software and/or firmware) stored on a memory accessible to the processor (e.g., memory, and/or the like). In some embodiments, the input/output unit includes or utilizes a user-facing application to provide input/output functionality.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and methods are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A system for an industrial plant logbook analysis by a neural network language model, comprising:
a processor;
a memory; and
one or more programs stored in the memory, the one or more programs comprising instructions configured to:
receive a logbook of the industrial plant;
extract an entity hierarchy flow providing details of a hierarchy of various components of the industrial plant, wherein the entity hierarchy flow is based on one or more of data driven algorithm, design documentation, and a plant context hierarchy document;
train the neural network language model with the entity hierarchy flow, wherein the training is based on a pretrained language model;
receive a user input requesting the industrial plant logbook analysis, wherein based on the user input:
calculate a token output of the industrial plant logbook analysis using the trained neural network language model;
validate the calculated token output by a generative AI validation layer,
wherein the generative AI validation layer is based on one or more of rule validations, parameter trend validations, and corroborative AI validations;
update the token output of the logbook analysis based on the validation by the generative AI validation layer; and
display the updated output of the logbook analysis to the user.

2. The system of claim 1, wherein the instructions are further configured to reject the calculated token output and report an error to the user.

3. The system of claim 1, wherein the instructions are further configured to retrain the neural network language model based on the token output validated by the generative AI validation layer.

4. The system of claim 1, wherein the instructions are further configured to update the entity hierarchy flow based on the industrial plant logbook analysis.

5. The system of claim 1, wherein the industrial plant logbook analysis comprises a logbook summary generation, an asset performance management, a user driven questions and answers, and a guide maintenance workflow.

6. The system of claim 5, wherein the logbook summary generation comprises managing one or more of incorrect spelling, grammatical inaccuracies, acronyms, industry specific abbreviated terms, and incomplete asset names.

7. The system of claim 5, wherein the user driven questions and answers provide results limited to one or more fields of the logbook queried by the user.

8. The system of claim 1, wherein the generative AI validation layer further validates the calculated token output based on data sources of the industrial plant and actual domain knowledge.

9. The system of claim 1, wherein the logbook of the industrial plant is in free text format.

10. The system of claim 1, wherein the extraction of the entity hierarchy flow and the training of the neural network language model are performed in an offline mode.

11. The system of claim 1, wherein the user input is a query to the neural network language model.

12. A method comprising:
receiving a logbook of an industrial plant;
extracting an entity hierarchy flow providing details of a hierarchy of various components of the industrial plant, wherein the entity hierarchy flow is based on one or more of data driven algorithm, design documentation and a plant context hierarchy document;
training a neural network language model with the entity hierarchy flow, wherein the training is based on a pretrained language model;
receiving a user input requesting an industrial plant logbook analysis, wherein based on the user input:
calculating a token output of the industrial plant logbook analysis using the trained neural network language model;
validating the calculated token output by a generative AI validation layer,
wherein the generative AI validation layer is based on one or more of rule validations, parameter trend validations and corroborative AI validations;
updating the token output of the logbook analysis based on the validation by the generative AI validation layer; and
displaying the updated output of the logbook analysis to the user.

13. The method of claim 12, further comprising:
rejecting the calculated token output and reporting an error to the user.

14. The method of claim 12, further comprising:
updating the entity hierarchy flow based on the industrial plant logbook analysis.

15. The method of claim 12, wherein the industrial plant logbook analysis comprises a logbook summary generation, an asset performance management, a user driven questions and answers and a guide maintenance workflow.

16. The method of claim 12, wherein the logbook summary generation comprises managing one or more of incorrect spelling, grammar inaccuracies, acronyms, industry specific abbreviated terms and incomplete asset names.

17. The method of claim 12, wherein the user driven questions and answers provide results limited to one or more fields of the logbooks queried by the user.

18. The method of claim 12, wherein the logbook of the industrial plant is in free text format.

19. The method of claim 12, wherein the extraction of the entity hierarchy flow and the training of the neural network language model are performed in an offline mode.

20. A non-transitory computer-readable storage medium comprising computer program code for execution by one or more processors of an apparatus, the computer program code configured to, when executed by the one or more processors, cause the apparatus to:
receive a logbook of an industrial plant;
extract an entity hierarchy flow providing details of a hierarchy of various components of the industrial plant, wherein the entity hierarchy flow is based on one or more of data driven algorithm, design documentation and a plant context hierarchy document;
train a neural network language model with the entity hierarchy flow, wherein the training is based on a pretrained language model;
receive a user input requesting an industrial plant logbook analysis, wherein based on the user input:
calculate a token output of the industrial plant logbook analysis using the trained neural network language model;
validate the calculated token output by a generative AI validation layer,
wherein the generative AI validation layer is based on one or more of rule validations, parameter trend validations and corroborative AI validations;
update the token output of the logbook analysis based on the validation by the generative AI validation layer; and
display the updated output of the logbook analysis to the user.
